(19) United States
(12) Patent Application Publication
(10) Pub. No.: US 2026/0088485 A1
(43) Pub. Date: Mar. 26, 2026

(54) ELECTRONIC DEVICE AND RADIATION DEVICE

(71) Applicant: WISTRON NEWEB CORPORATION, HSINCHU (TW)

(72) Inventors: SHIH-CHIANG WEI, HSINCHU (TW); CHI-JUI HO, HSINCHU (TW); YEN-TZE PENG, HSINCHU (TW)

(21) Appl. No.: 19/008,759

(22) Filed: Jan. 3, 2025

Related U.S. Application Data
(60) Provisional application No. 63/697,615, filed on Sep. 23, 2024.

(30) Foreign Application Priority Data
Nov. 20, 2024 (TW) 113144546

(51) Int. Cl. H01Q 1/22; H01Q 1/50; H01Q 5/20; H01Q 7/00

(52) U.S. Cl. CPC H01Q 1/2266; H01Q 5/20; H01Q 7/00; H01Q 1/50

(57) ABSTRACT

The electronic device includes a metal base housing, a holder disposed within the metal base housing, and an antenna disposed on the holder. A sidewall of the metal base housing has a slot. The holder includes an upper surface, a first side surface, and a lower surface. The antenna includes a feed part, a radiation part, and a grounding part. At least a portion of the radiation part is distributed on the upper surface. At least a portion of the grounding part is distributed on the lower surface. At least a portion of one or more of the feed part, the radiation part, and the grounding part is distributed on the first side surface, and defines a projection area that is projected towards the sidewall and that at least partially overlaps with the slot, and the first side surface is adjacent to the sidewall.

### CROSS-REFERENCE TO RELATED PATENT APPLICATION

This application claims the benefit of priority to Taiwan Patent Application No. 113144546, filed on Nov. 20, 2024. The entire content of the above identified application is incorporated herein by reference.

This application claims the benefit of priority to the U.S. Provisional Patent Application Ser. No. 63/697,615 filed on Sep. 23, 2024, which is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an electronic device and a radiation device, particularly an electronic device and a radiation device with an antenna.

### BACKGROUND OF THE DISCLOSURE

With the advancement of mobile communication technology, mobile electronic devices have become increasingly common, some commonly seen mobile electronic devices being laptop computers, mobile phones, and tablet computers. In recent years, the design of mobile electronic devices tend to be smaller, lighter, and more convenient; hence in addition to considering functionality, the overall product should also be as thin, light, easy to manufacture, low-cost, aesthetically pleasing, and user-friendly as possible. Various research and technologies in such design trends are constantly evolving. To pursue thinness, aesthetics and structural strength, current laptop computers, tablet computers, and other electronic products often use metal materials for the body, but such metal materials will affect signal reception and transmission of the antenna.

Additionally, to satisfy more usage scenarios for the user, electronic devices may have various operating modes, such as Notebook Mode, Closed Mode, Stand Mode, Tablet Mode, and Tent Mode. Under different operating modes, the antenna might be blocked by the cover, screen, keyboard, or other components of the device body, affecting signal reception and transmission. For example, a conventional antenna may work normally in Notebook Mode but may experience degraded signal quality in Closed Mode due to the cover blocking the antenna.

Besides the aforementioned metal materials and different operating modes affecting signal quality, mobile electronic devices also face challenges on size design. A metal housing without a radiation clearance area can degrade antenna characteristics and fail to meet modern communication standards' broadband requirements, such as broadband requirements for Wi-Fi 7 (approximately 2400 to 2500 MHz and 5150 to 7125 MHz). However, due to size constraints, the radiation clearance area cannot be made large. Overall considering the issues of materials, operating modes, size, and bandwidth, designing mobile electronic devices becomes extremely difficult.

In view of the above, a new technical solution is needed to address the aforementioned issues.

### SUMMARY OF THE DISCLOSURE

In some embodiments, an electronic device is provided, the electronic device includes: a metal base housing including a sidewall, and the metal base housing having at least one slot located in the sidewall; a holder being disposed within the metal base housing, the holder including an upper surface, a first side surface, and a lower surface; an antenna including a feed part, a radiation part, and a grounding part, the antenna being disposed on the holder such that at least a portion of the radiation part of the antenna is distributed on the upper surface of the holder; at least a portion of the grounding part of the antenna is distributed on the lower surface of the holder; and at least a portion of one or more of the feed part, the radiation part, and the grounding part of the antenna is distributed on the first side surface of the holder; wherein a projection area of the portion of the antenna located on the first side surface projected towards the sidewall of the metal base housing at least partially overlaps with the slot; and the first side surface of the holder is adjacent to the sidewall.

In some embodiments, a distance between the sidewall and the portion of the antenna located on the first side surface is less than 3 mm.

In some embodiments, the antenna is operable at a first frequency band and a second frequency band, the first frequency band is between 2400 MHz and 2500 MHz, and the second frequency band is between 5150 MHz and 7125 MHz.

In some embodiments, a length of the slot is approximately 0.4 to 0.6 times the wavelength corresponding to the first frequency band, or approximately ⅔ to ¾ times the wavelength corresponding to the first frequency band.

In some embodiments, a total length of the radiation part of the antenna is approximately 0.4 to 0.6 times the wavelength corresponding to the first frequency band.

In some embodiments, the antenna is a loop antenna.

In some embodiments, the antenna is configured to radiate in a first direction and a second direction and is configured to excite the slot such that the slot also radiates in the first direction and the second direction, wherein the first direction is different from the second direction.

In some embodiments, the radiation part includes a first segment, a second segment, and a third segment, wherein each of the first segment, the second segment, and the third segment has a strip shape, the first segment is coupled to the feed part and disposed opposite to the third segment, and the second segment is coupled between the first segment and the third segment.

In some embodiments, the radiation part further includes a protrusion, the protrusion being coupled to the second segment and located between the first segment and the third segment, wherein the protrusion has a rectangular shape.

In some embodiments, the grounding part of the antenna is directly or indirectly coupled to the metal base housing via one or more of: a screw, a spring plate, a conductive gasket, and a metal foil.

In some embodiments, the electronic device further comprises a metal shield, wherein: the holder is located between the sidewall of the metal base housing and the metal shield; and the holder further includes a second side surface opposite to the first side surface, wherein the second side surface is closer to the metal shield than the first side surface.

In some embodiments, the electronic device further includes a keyboard frame being disposed above the metal base housing, wherein: the metal base housing further includes a base bottom, the base bottom is opposite to the keyboard frame, and the sidewall is located between the base bottom and the keyboard frame; and the metal shield is coupled to one or both of: the keyboard frame and the base bottom.

In some embodiments, a radiation device is provided, the radiation device includes: a metal wall having a slot located within; a holder including an upper surface, a side surface, and a lower surface; an antenna including a feed part, a radiation part, and a grounding part, the antenna being disposed on the holder such that: at least a portion of the radiation part of the antenna is distributed on the upper surface of the holder; at least a portion of the grounding part of the antenna is distributed on the lower surface of the holder; and at least a portion of one or more of the feed part, the radiation part, and the grounding part of the antenna is distributed on the side surface of the holder; wherein: a projection area of the portion of the antenna located on the side surface projected towards the metal wall at least partially overlaps with the slot; and the side surface of the holder is adjacent to the metal wall.

In some embodiments, a distance between the metal wall and the portion of the antenna located on the side surface is less than 3 mm.

To further understand the features and technical content of the present disclosure, please refer to the following detailed description and drawings. However, the provided drawings are only for reference and illustration and are not intended to limit the present disclosure.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIGS. 1A-1D show schematic views of various operating modes of an electronic device according to an embodiment of the present disclosure.

FIG. 2A shows a schematic view of an electronic device and a hybrid antenna therein according to an embodiment of the present disclosure.

FIG. 2B shows a front view of a base housing of the electronic device according to an embodiment of the present disclosure.

FIG. 2C shows a front view and a side cross-sectional view of the hybrid antenna according to an embodiment of the present disclosure.

FIG. 3 shows an unfolded view of the hybrid antenna according to an embodiment of the present disclosure.

FIGS. 4 and 5 show measurement graphs of the Voltage Standing Wave Ratio (VSWR) and efficiency according to an embodiment of the present disclosure.

FIGS. 6 and 7 show measurement graphs of the Voltage Standing Wave Ratio (VSWR) and efficiency according to another embodiment of the present disclosure that is different from FIGS. 4 and 5.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on. ” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

Those skilled in the art can understand the advantages and effects of the present disclosure from the content disclosed in this specification. The present disclosure can be implemented or applied through other different specific embodiments, and the details in this specification can be modified and changed in various ways without departing from the spirit of the present disclosure. Additionally, the drawings of the present disclosure are only simple schematic illustrations and are not drawn to actual dimensions. The following embodiments will further detail the relevant technical content of the present disclosure, but the disclosed content is not intended to limit the scope of protection of the present disclosure. It should also be understood that although terms like “first,” “second,” and “third” may be used to describe various components, these components should not be limited by these terms. These terms are mainly used to distinguish one component from another.

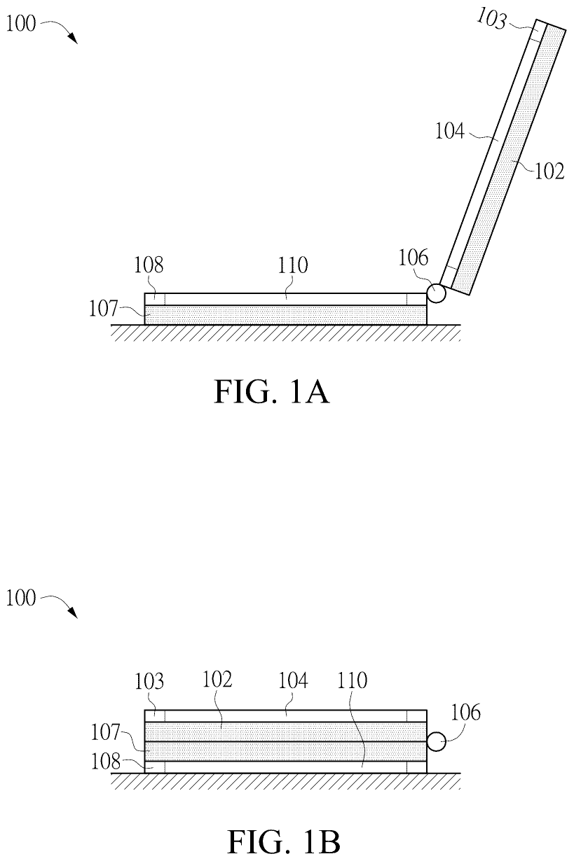

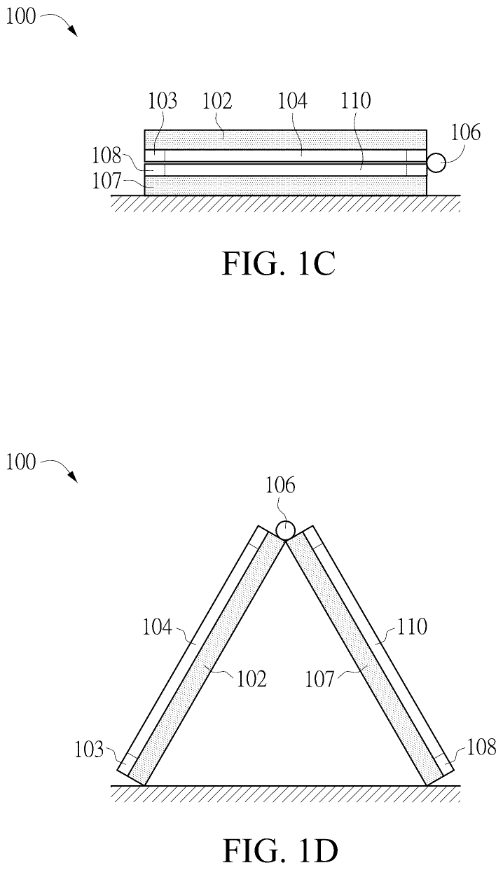

FIGS. 1A to 1D show various modes of an electronic device 100 according to an embodiment of the present disclosure. The electronic device 100 includes a cover housing 102, a display frame 103, a display 104, a hinge 106, a base housing 107, a keyboard frame 108, and a keyboard 110. The display 104 can be embedded in the display frame 103, and the keyboard 110 can be embedded in the keyboard frame 108. In related technical fields, the cover housing 102, the display frame 103, the keyboard frame 108, and the base housing 107 are commonly referred to as “A-part,” “B-part,” “C-part,” and “D-part” in laptop computers.

The electronic device 100 in the embodiment shown in FIGS. 1A to 1D is a laptop, which can have the screen or base being rotatable along the hinge 106 to operate in various modes; wherein, FIG. 1A shows the Notebook Mode, FIG. 1B shows the Tablet Mode, FIG. 1C shows the Closed Mode, and FIG. 1D shows the Tent Mode. The antenna of a conventional electronic device (not shown) is generally disposed at the cover housing 102, the display frame 103, the base housing 107, or the keyboard frame 108 as needed. The Notebook Mode shown in FIG. 1A is the normal operation mode; in this mode, since the laptop is open, there is space between the base housing 107 and the cover housing 102 for radiation of the antenna, so the signal reception and transmission quality in this mode is generally better than other modes. In the Tablet Mode shown in FIG. 1B, the user rotates the laptop along the hinge 106 so that the display 104 and keyboard 110 face outward, while the cover housing 102 and the base housing 107 face inward, allowing the laptop to be used as a tablet. In the Closed Mode shown in FIG. 1C, the laptop is also rotated along the hinge 106 but in a direction opposite to the Tablet Mode, such that the display 104 and the keyboard 110 face inward, while the cover housing 102 and the base housing 107 face outward, allowing the laptop to be used by connecting to an external display, or be easily carried by the user. It is worth noting that the laptop in the Closed Mode may still need to receive and transmit internet signals. In the Tent Mode shown in FIG. 1D, there is some space left between the cover housing 102 and the base housing 107, allowing the laptop to stand on a table, enabling the user to view the display 104 from a more comfortable angle. However, whether in Tablet Mode, Closed Mode, or Tent Mode, the radiation space for the antenna is significantly reduced, so the signal reception and transmission quality may be affected by one or more of the desk surface, the cover housing 102, the display frame 103, the display 104, the base housing 107, the keyboard frame 108, or the keyboard 110, regardless of where the antenna is set. In addition to the Notebook Mode, Tablet Mode, Closed Mode, and Tent Mode mentioned above, laptops may have other operating modes or variations, but the antenna may encounter similar problems as described above. Furthermore, although the above content uses laptops as an example, other types of electronic devices may also experience signal quality issues due to different operating modes; for example, tablets can operate in Notebook Mode, Tablet Mode, Closed Mode, and Tent Mode when connected to a detachable keyboard.

To overcome the above problems, the present disclosure provides a hybrid antenna capable of radiating in different directions, so even if the radiation in one direction is affected by the electronic device's different modes, the hybrid antenna still has radiation in other directions to maintain signal reception and transmission quality.

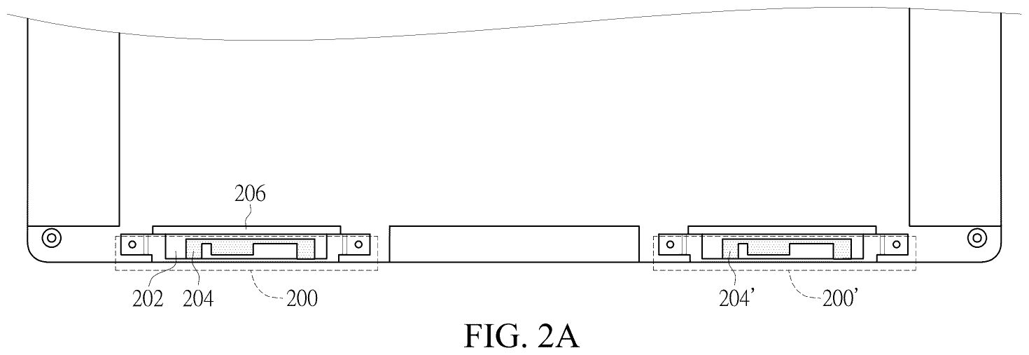

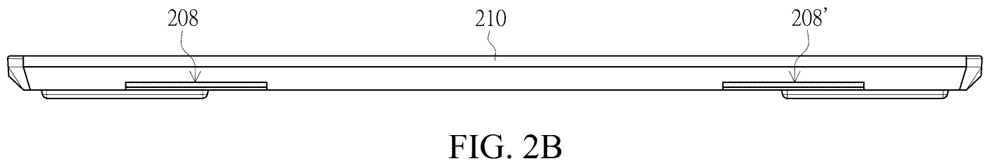

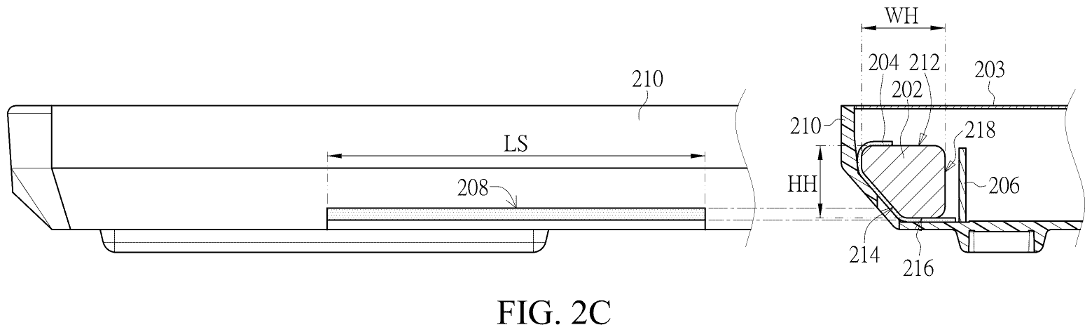

Refer to FIGS. 2A to 2C, which show a schematic view of a hybrid antenna 200 disposed in an electronic device according to an embodiment of the present disclosure. Although the electronic device in this embodiment is a laptop, the hybrid antenna can be applied to other types of electronic devices. The hybrid antenna 200 in this embodiment is disposed at the border of the “D-part” (base housing) of the laptop, but in other embodiments, the hybrid antenna 200 can be applied at other positions of the laptop as needed.

As shown in FIGS. 2A and 2B, the electronic device is equipped with two hybrid antennas 200, 200′, where the hybrid antenna 200 includes a loop antenna 204 and a slot 208, while the hybrid antenna 200′ includes a loop antenna 204′ and a slot 208′. The hybrid antennas 200 and 200′ can be the same or different. This embodiment shows the same hybrid antennas 200, 200′, so only the hybrid antenna 200 will be described below. In variant embodiments, the size of the hybrid antenna 200′ can be different from the hybrid antenna 200 so as to cover signal reception and transmission of different frequency bands, but their means of operation and structure are similar, so the description is not be repeated herein. Additionally, in variant embodiments, the electronic device can have other quantities of hybrid antennas (e.g., one, or three or more).

Referring to FIGS. 2A and 2C, the loop antenna 204 is disposed on the holder 202, wherein the width WH and height HH of the holder 202 in the cross-sectional view are approximately 8 mm and 7 mm, respectively. The holder 202 includes an upper surface 212, a first side surface 214, a lower surface 216, and a second side surface 218. The holder 202 is disposed within the metal base housing of the electronic device; a keyboard frame can be disposed above the corresponding metal base housing, wherein the upper surface 212 of the holder 202 is closer to the keyboard frame than the lower surface 216. The second side surface 218 is opposite to the first side surface 214, and in this embodiment, the first side surface 214 is an inclined surface, while the second side surface 218 is a vertical surface; however, in variant embodiments, the first side surface 214 and the second side surface 218 can be set as vertical or inclined as needed. A metal shield 206 can also be disposed within the metal base housing of the electronic device to prevent the signal of the hybrid antenna 200 from interfering with other components (e.g., battery, motherboard, etc.) inside the electronic device. As shown in FIG. 2C, the metal shield 206 is disposed near the second side surface 218 of the holder 202, such that the holder 202 is located between a sidewall 210 of the metal base housing and the metal shield 206. Furthermore, the metal base housing of the electronic device includes a base bottom coupled to the lower edge of the sidewall 210; wherein, the lower surface 216 of the holder 202 is closer to the base bottom of the metal base housing than the upper surface 212, and the metal shield 206 can be coupled to one or both of the following: (1) keyboard frame, and (2) the base bottom of the metal base housing. It should be noted that the sidewall 210 can be any front, rear, left or right wall of the metal base housing, and the hybrid antenna of the present disclosure can be disposed on one or more sidewalls 210.

The loop antenna 204 is configured to be distributed on the upper surface 212, the first side surface 214, and the lower surface 216 of the holder 202. The metal base housing of the electronic device includes the sidewall 210, and a slot 208 is opened in the sidewall 210. The slot 208 can have various forms, such as a straight line, L-shape, or other suitable shapes. The first side surface 214 of the holder 202 is adjacent to the sidewall 210, particularly adjacent to the slot 208 in the sidewall 210. Since at least a portion of the loop antenna 204 is disposed on the first side surface 214 of the holder 202, the loop antenna 204 is also adjacent to the sidewall 210. The term “adjacent” in the present disclosure can refer to two elements having a spacing of 3 mm or less, or being in direct abutment. For example, in some embodiments, a gap between the loop antenna 204 (particularly the portion distributed on the first side surface 214) and the sidewall 210 can be within a range from 0.001 mm to 3 mm, such as about 0.5 mm; or the loop antenna 204 can directly abut against the sidewall 210 with an insulation coating provided in-between for insulation. A projection area of the first side surface 214 of the holder 202 projected towards the sidewall 210 at least partially overlaps with the slot 208, and a projection area of the loop antenna 204 disposed on the holder 202 projected towards the sidewall 210 also at least partially overlaps with the slot 208. The above configuration of the loop antenna 204 and the slot 208 enables the loop antenna 204 to excite the slot 208, causing the slot 208 to radiate. In some embodiments, the loop antenna 204 radiates in a first direction and a second direction, wherein radiation in the first direction generally radiates outward from the loop antenna 204 towards the keyboard frame 203 of the electronic device; the first direction is different from the second direction, and radiation in the second direction generally radiates towards the slot 208 and simultaneously excites the slot 208, causing an excited slot 208 to also radiate in both the first direction and the second direction. Based on this design, if signal reception and transmission in the first direction of the loop antenna 204 are affected by components such as the cover housing, display frame, display, etc. under different operating modes of the electronic device such as Tablet Mode, Closed Mode, or Tent Mode, the slot 208 excited by the loop antenna 204 can still radiate in different directions (e.g., the second direction) to maintain signal reception and transmission quality. Therefore, by implementing the hybrid antenna of the present disclosure to electronic devices, the electronic devices can maintain good signal reception and transmission quality under different operating modes.

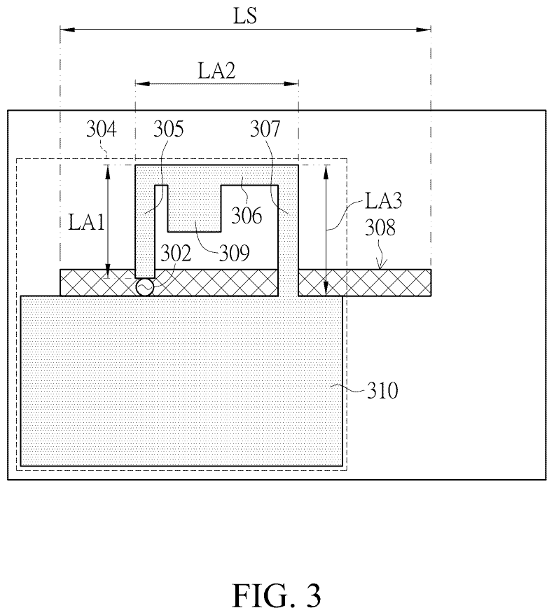

Refer to FIG. 3, which shows a projected overlapping position of an unfolded view of the loop antenna 304 relative to the of the slot 308, wherein the loop antenna 304 and the slot 308 can correspond to the loop antenna 204 and the slot 208 in FIGS. 2A-2C, respectively. The loop antenna 304 includes a feed part 302, a radiation part, and a grounding part 310, wherein the radiation part includes a first segment 305, a second segment 306, and a third segment 307. The first segment 305, the second segment 306, and the third segment 307 each have a strip shape, wherein the first segment 305 is coupled to the feed part 302 and positioned opposite to the third segment 307, while the second segment 306 is coupled between the first segment 305 and the third segment 307. The first segment 305 and the grounding part 310 are respectively connected to two ends of the feed part 302, wherein the grounding part 310 is grounded. The grounding part 310 can be directly or indirectly coupled to the metal base housing of the electronic device through one or more of: a screw, a spring plate, a conductive gasket, and a metal foil (such copper foil), etc. In some embodiments, the radiation part further includes a protrusion 309, the protrusion 309 being coupled to the second segment 306 and located between the first segment 305 and the third segment 307. The protrusion 309 can be used to adjust the impedance matching of the loop antenna 304 to optimize the efficiency of signal transmission from the feed part 302 to the loop antenna 304. The specific position and shape of the protrusion 309 can be adjusted according to the matching requirements. In this embodiment, the protrusion 309 has a rectangular shape, but in variant embodiments, the protrusion 309 can have other shapes, such as circular, triangular, or other polygonal shapes, etc.

The hybrid antenna of the present disclosure can operate in a first frequency band and a second frequency band, the first frequency band being between approximately 2400 MHz to 2500 MHz, and the second frequency band being between approximately 5150 MHz to 7125 MHz. To operate in the aforementioned frequency bands, the loop antenna 304 and the slot 308 can have corresponding dimensions. For example, a total length LA1+LA2+LA3 of the first segment 305, the second segment 306, and the third segment 307 of the loop antenna 304 can be approximately 0.4 to 0.6 times the wavelength (such as 0.5 times the wavelength) corresponding to the first frequency band, wherein in this embodiment, LA1, LA2, and LA3 are approximately 11 mm, 14 mm, and 12.5 mm, respectively. The length LS of the slot 308 can be approximately 0.4 to 0.6 times the wavelength (such as 0.5 times the wavelength) corresponding to the first frequency band, or approximately ⅔ to ¾ times the wavelength corresponding to the first frequency band. For example, in some embodiments, the length LS is approximately 38 mm. In some variant embodiments, two or more hybrid antennas can be deployed so as to cover operating frequency bands of different ranges.

As shown in FIG. 3, the loop antenna 304 and the slot 308 have overlapping projection areas. In this embodiment, the projection area of the feed part 302 completely overlaps with the slot 308, the projection area of the grounding part 310 is tangential to the slot 308 but does not overlap with the slot 308, and the projection areas of the first segment 305 and the third segment 307 partially overlap with the slot 308. In some variant embodiments, the relative projection position of the loop antenna 304 and the slot 308 can be changed (e.g., moved up, down, left, or right). For example, in some embodiments, the projection area of the feed part 302 may be near the slot 308 without overlapping, or the projection area of the grounding part 310 may partially overlap with the slot 308.

As previously described with respect to FIG. 2C, the loop antenna 304 is disposed on the holder (not shown in FIG. 3), wherein the feed part 302, the first segment 305, the second segment 306, the third segment 307, and the grounding part 310 of the loop antenna 304 can be distributed on the upper surface (e.g., the upper surface 212 in FIG. 2C), side surface (e.g., the first side surface 214 in FIG. 2C), or lower surface (e.g., the lower surface 216 in FIG. 2C) of the holder. Specifically, at least a portion of the radiation part (including the first segment 305, the second segment 306, the third segment 307, and the protrusion 309) of the loop antenna 304 is distributed on the upper surface of the base; at least a portion of the grounding part 310 of the loop antenna 304 is distributed on the lower surface of the base; and at least a portion of one or more of the feed part 302, the radiation part, and the grounding part 310 of the loop antenna 304 is distributed on the side surface of the holder.

In variant embodiments, the loop antenna 204 can be replaced with other types of antennas, including but not limited to monopole antennas, dipole antennas, patch antennas, planar inverted F antennas (PIFA), cavity antennas, etc.; the present disclosure includes such variant embodiments.

The above description uses a laptop as an example of the electronic device to explain the implementation of the hybrid antennas 200, 200′, but the implementation of the present disclosure is not limited to laptops, and the hybrid antennas 200, 200′ in FIGS. 2A to 3 can have different implementations. For example, the hybrid antennas 200, 200′ in FIGS. 2A to 3 can be implemented in a radiation device, and the radiation device can be any device that radiates electromagnetic waves. The radiation device includes: a metal wall with a slot located therein; a holder including an upper surface, a side surface, and a lower surface; an antenna including a feed part, a radiation part, and a grounding part, the antenna being disposed on the holder such that: at least a portion of the radiation part of the antenna is distributed on the upper surface of the holder; at least a portion of the grounding part of the antenna is distributed on the lower surface of the holder; and at least a portion of one or more of the feed part, the radiation part, and the grounding part of the antenna is distributed on the side surface of the holder; wherein: a projection area of the portion of the antenna located on the side surface projected towards the metal wall at least partially overlaps with the slot; and the side surface of the holder is adjacent to the metal wall. A distance between the metal wall and the portion of the antenna located on the side surface can be less than 3 mm. The radiation device can be modified according to the aforementioned content, and such modifications are not repeated herein.

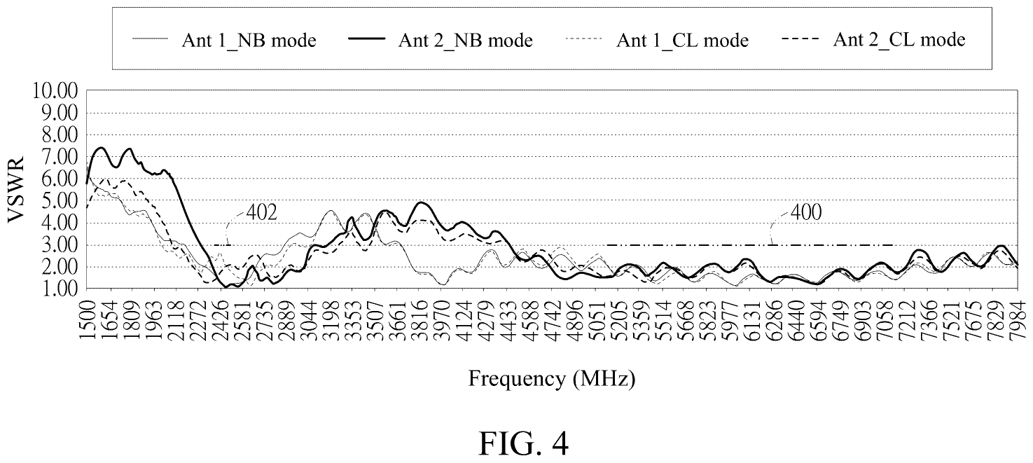

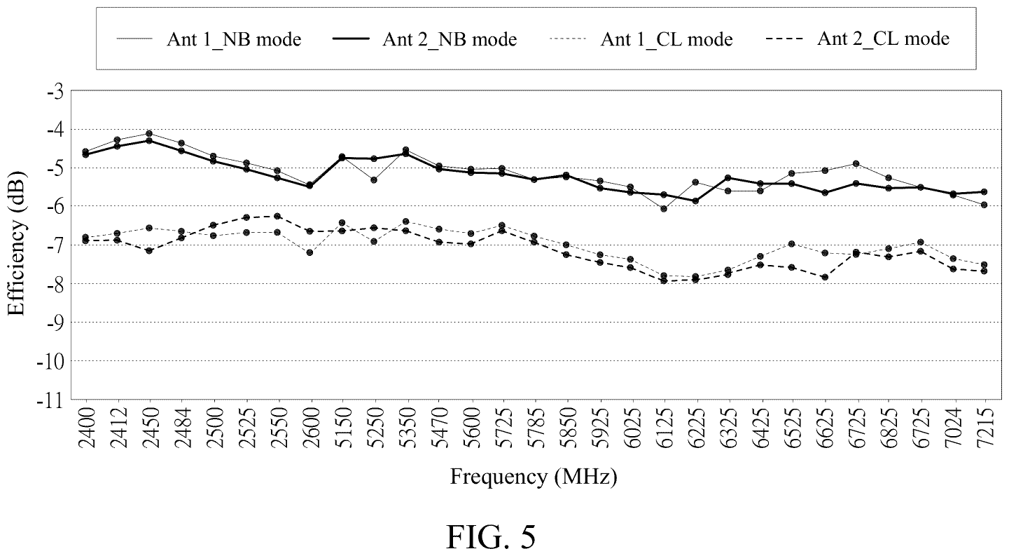

FIGS. 4 and 5 show Voltage Standing Wave Ratio (VSWR) and efficiency to frequency graphs for the hybrid antenna according to an embodiment of the present disclosure. The electronic device in the embodiment of FIGS. 4 and 5 is equipped with two hybrid antennas, Ant1 and Ant2, which can be deployed as shown in FIG. 2A. The overall maximum dimensions of the hybrid antennas Ant1 and Ant2 are 60 mm in length, 8 mm in width, and 7 mm in height, and the length of the slot of the hybrid antennas Ant1 and Ant2 is approximately 0.5 times the wavelength corresponding to the operating frequency band, which is approximately 38 mm. As shown by the reference lines 400, 402 in FIG. 4, the hybrid antennas Ant1 and Ant2 have good VSWR measurement results in both frequency ranges of approximately 2400 MHz to 2500 MHz and approximately 5150 MHz to 7125 MHz, regardless of whether the electronic device is in Notebook Mode (NB Mode) or Closed Mode (CL Mode). As shown in FIG. 5, the hybrid antennas Ant1 and Ant2 also exhibit good efficiency measurement results in the aforementioned frequency ranges. It can be seen that the electronic device equipped with the hybrid antennas Ant1 and Ant2 can still maintain good signal reception and transmission quality under different operating modes.

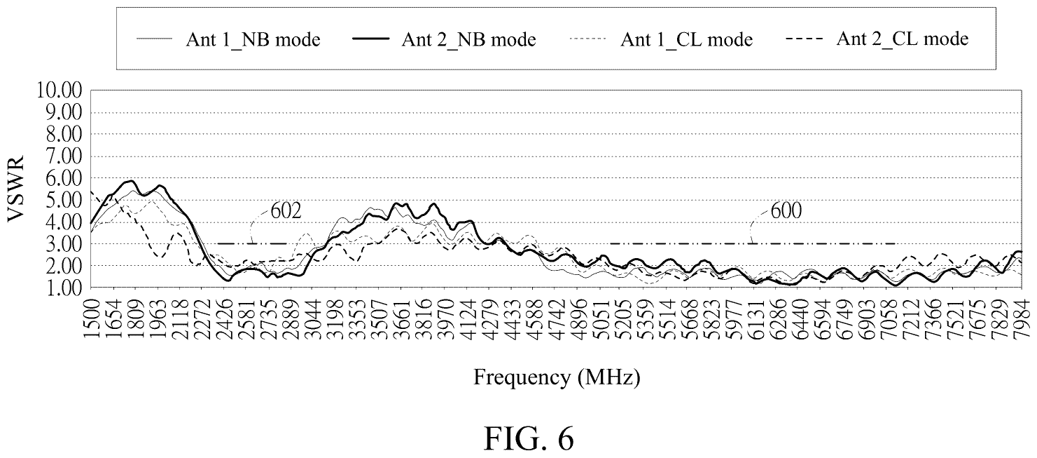

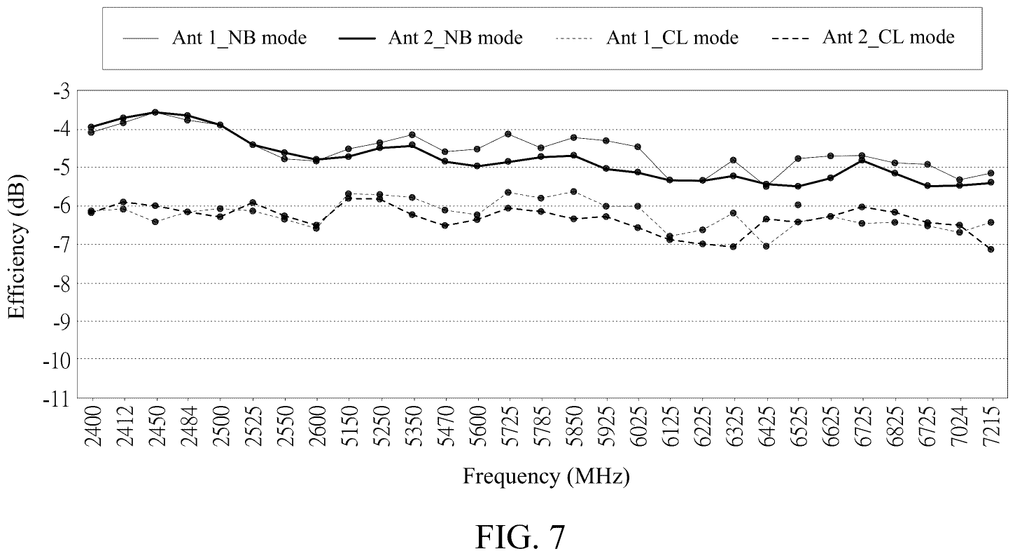

FIGS. 6 and 7 show VSWR and efficiency to frequency graphs for the hybrid antennas Ant1 and Ant2 according to another embodiment of the present disclosure. The difference between this embodiment and the aforementioned embodiment in FIGS. 4 and 5 is that the length of the slot is extended to approximately ¾ times the wavelength corresponding to the operating frequency band, which is approximately 55 mm. As shown by the reference lines 600, 602 in FIG. 6 and FIG. 7, the hybrid antennas Ant1 and Ant2 still have good VSWR and efficiency measurement results in frequency ranges of approximately 2400 MHz to 2500 MHz and the approximately 5150 MHz to 7125 MHz, regardless of whether the electronic device is in Notebook Mode (NB Mode) or Closed Mode (CL Mode). Compared to the previous embodiment in FIGS. 4 and 5, the measurement results of this embodiment in the 2.5 GHz range (at position 602) show a wider operating frequency band. In the embodiment of FIGS. 6 and 7, the hybrid antennas Ant1 and Ant2 also exhibit good performance in the aforementioned operating frequency bands when the electronic device operates in the Notebook Mode and Closed Mode. In actual applications, the appropriate hybrid antenna can be selected based on considerations such as the size limitations, specification requirements, and cost of the electronic device.

The foregoing description of the exemplary embodiments of the present disclosure has been presented only for the purposes of illustration and description and is not intended to be exhaustive or to limit the present disclosure. Many modifications and variations are possible in light of the above teaching.

The embodiments were chosen and described in order to explain the principles of the present disclosure and their practical applications. Alternative embodiments will become apparent to those skilled in the art to which the present disclosure pertains without departing from its spirit and scope.

What is claimed is:

1. An electronic device, comprising:
a metal base housing including a sidewall, the metal base housing having at least one slot located in the sidewall;
a holder being disposed within the metal base housing, the holder including an upper surface, a first side surface, and a lower surface; and
an antenna including a feed part, a radiation part, and a grounding part, the antenna being disposed on the holder such that:
at least a portion of the radiation part of the antenna is distributed on the upper surface of the holder;
at least a portion of the grounding part of the antenna is distributed on the lower surface of the holder; and
at least a portion of one or more of the feed part, the radiation part, and the grounding part of the antenna is distributed on the first side surface of the holder;
wherein:
a projection area of the portion of the antenna distributed on the first side surface projected towards the sidewall of the metal base housing at least partially overlaps with the slot; and
the first side surface of the holder is adjacent to the sidewall.

2. The electronic device according to claim 1, wherein a distance between the sidewall and the portion of the antenna distributed on the first side surface is less than 3 mm.

3. The electronic device according to claim 1, wherein the antenna is operable at a first frequency band and a second frequency band, and wherein the first frequency band is between 2400 MHz and 2500 MHz, and the second frequency band is between 5150 MHz and 7125 MHz.

4. The electronic device according to claim 3, wherein a length of the slot is 0.4 to 0.6 times a wavelength corresponding to the first frequency band, or ⅔ to ¾ times the wavelength corresponding to the first frequency band.

5. The electronic device according to claim 3, wherein a total length of the radiation part of the antenna is 0.4 to 0.6 times a wavelength corresponding to the first frequency band.

6. The electronic device according to claim 1, wherein the antenna is a loop antenna.

7. The electronic device according to claim 1, wherein the antenna is configured to radiate in a first direction and a second direction and is configured to excite the slot, such that the slot radiates in the first direction and the second direction, and wherein the first direction is different from the second direction.

8. The electronic device according to claim 1, wherein the radiation part includes a first segment, a second segment, and a third segment, and wherein each of the first segment, the second segment, and the third segment has a strip shape, the first segment is coupled to the feed part and disposed opposite to the third segment, and the second segment is coupled between the first segment and the third segment.

9. The electronic device according to claim 8, wherein the radiation part further includes a protrusion, wherein the protrusion is coupled to the second segment and located between the first segment and the third segment, and wherein the protrusion has a rectangular shape.

10. The electronic device according to claim 1, wherein the grounding part of the antenna is directly or indirectly coupled to the metal base housing via one or more of: a screw, a spring plate, a conductive gasket, and a metal foil.

11. The electronic device according to claim 1, further comprising a metal shield, wherein:
the holder is located between the sidewall of the metal base housing and the metal shield; and
the holder further includes a second side surface opposite to the first side surface, wherein the second side surface is closer to the metal shield than the first side surface.

12. The electronic device according to claim 11, further comprising a keyboard frame, the keyboard frame being disposed above the metal base housing, wherein:
the metal base housing further includes a base bottom, the base bottom is opposite to the keyboard frame, and the sidewall is located between the base bottom and the keyboard frame; and
the metal shield is coupled to one or both of: the keyboard frame and the base bottom.

13. A radiation device, comprising:
a metal wall having a slot located therein;
a holder including an upper surface, a side surface, and a lower surface; and
an antenna including a feed part, a radiation part, and a grounding part, the antenna being disposed on the holder such that:
at least a portion of the radiation part of the antenna is distributed on the upper surface of the holder;
at least a portion of the grounding part of the antenna is distributed on the lower surface of the holder; and
at least a portion of one or more of the feed part, the radiation part, and the grounding part of the antenna is distributed on the side surface of the holder;
wherein:
a projection area of the portion of the antenna distributed on the side surface projected towards the metal wall at least partially overlaps with the slot; and
the side surface of the holder is adjacent to the metal wall.

14. The radiation device according to claim 13, wherein a distance between the metal wall and the portion of the antenna distributed on the side surface is less than 3 mm.
